(19) United States
(12) Patent Application Publication
(10) Pub. No.: US 2017/0134181 A1
(43) Pub. Date: May 11, 2017

(54) METHOD AND DEVICE FOR DATA PUSH

(71) Applicant: Alibaba Group Holding Limited, Grand Cayman (KY)

(72) Inventors: Baohua Wu, Hangzhou (CN); Dengbo Fu, Hangzhou (CN); Yunfeng Gan, Hangzhou (CN); Naihan Huang, Hangzhou (CN)

(21) Appl. No.: 15/347,555

(22) Filed: Nov. 9, 2016

(30) Foreign Application Priority Data
Nov. 9, 2015 (CN) 201510755264.2

(51) Int. Cl. H04L 12/18; H04N 21/235; H04L 29/08

(52) U.S. Cl. CPC H04L 12/1859; H04L 67/26; H04L 67/22; H04L 67/306; H04L 12/185; H04N 21/2353; H04H 60/33

(57) ABSTRACT

A method for data push is disclosed. The method includes obtaining user group distinct feature information about a request-to-push party and similarity weight information of each distinct feature based on user-related information of target users of the request-to-push party; obtaining user group feature information of a wait-for-push party corresponding to user group distinct feature information of the request-to-push party based on user-related information of specific users of the wait-for-push party; obtaining user group similarity information between the request-to-push party and the wait-for-push party based on the similarity weight information, the user group distinct feature information of the request-to-push party, and the user group feature information of the wait-for-push party; and determining whether to send related push information of the request-to-push party to the wait-for-push party for pushing based on the user group similarity information, thus effectively improving the precision and intellectualization of the data push.

### CROSS REFERENCE TO RELATED PATENT APPLICATION

This application claims foreign priority to Chinese Patent Application No. 201510755264.2 filed on Nov. 9, 2015, entitled “Method and Apparatus for Data Push”, which is hereby incorporated by reference in its entirety.

### TECHNICAL FIELD

The present disclosure relates to the field of computing devices, and in particular to data pushing technologies.

### BACKGROUND

With the flourishing of network information over the Internet, radio and television industries, for example, generate a massive volume of interaction data during data interaction, which provides a great value for precision and intellectualization of network broadcasting, such as conventional radio and television, by integration and mining of interaction data of e-business users.

However, a majority of data push analyses of network broadcasting, e.g., conventional radio and television, are based on information of users of TV program and user attributes that is obtained from subjective judgment of e-business service providers and TV program provider, and small-scale questionnaires, in which a population matching judgment is conducted. This lacks an objective big data analysis on the e-business service providers and the target audience population of the TV programs. In an e-business service provider's decision of data push to a TV program, user interaction data of the e-business service provider and the TV program are collected through small sample questionnaires or subjective assumptions. As a result, the degree of automation is low and interaction data cannot be processed quantitatively. Moreover, as user group attribute features in interaction data that is surveyed are relatively fixed and cannot be extrapolated relevantly, distinct user features of an e-business service provider that may affect a data push decision cannot be explored at a deeper level, as is product loyalty of users of a TV program. In addition, due to limitations of subjective assumptions or questionnaires, the decision of whether to integrate interaction data between an e-business provider and a TV program lacks guidance from scientific big data, and the result of the decision is low precision and intellectualization.

Likewise, when request-to-push parties, which are similar to e-business service providers, push data information that needs to be pushed to wait-for-push parties that are similar to TV programs, all data push solutions that are determined via a data analysis performed by means of small sample questionnaires or subjective assumptions will cause a low degree of automation and a low degree of quantization, thus resulting in low precision and intellectualization of a data push decision.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

An objective of the present disclosure is to provide a method and a device for data push, to solve the problem of poor degrees of automation and quantization resulted from small sample questionnaires or subjective assumptions that are used for determining data push solutions when a request-to-push party pushes data information that needs to be pushed to a wait-for-push party in existing technologies, which results in low precision and intellectualization of a data push decision.

To solve the foregoing technical problem, a method for data push is provided according to an aspect of the present disclosure, which may include:

obtaining user-related information of target users of a request-to-push party, obtaining user group distinct feature information about the request-to-push party based on the user-related information of the target users of the request-to-push party, and obtaining similarity weight information of each distinct feature based on the user group distinct feature information of the request-to-push party, wherein the user group distinct feature information comprises distinct features and ratio information of user groups having the distinct features corresponding thereto;

obtaining user-related information of specific users of a wait-for-push party, and obtaining user group feature information of the wait-for-push party corresponding to the user group distinct feature information of the request-to-push party, based on the user-related information of the specific users of the wait-for-push party;

obtaining user group similarity information between the request-to-push party and the wait-for-push party based on the similarity weight information, the user group distinct feature information of the request-to-push party, and the user group feature information of the wait-for-push party; and

determining whether to send related push information of the request-to-push party to the wait-for-push party for pushing based on the user group similarity information.

According to another aspect of the present disclosure, a device for data push is provided, which may include:

a request-to-push party acquisition apparatus to obtain user-related information of target users of a request-to-push party, obtaining user group distinct feature information about the request-to-push party based on the user-related information of the target users of the request-to-push party, and obtaining similarity weight information of each distinct feature based on the user group distinct feature information of the request-to-push party, wherein the user group distinct feature information comprises distinct features and ratio information of user groups having the distinct features corresponding thereto;

a wait-for-push party acquisition apparatus to obtain user-related information of specific users of a wait-for-push party, and obtaining user group feature information of the wait-for-push party corresponding to the user group distinct feature information of the request-to-push party, based on the user-related information of the specific users of the wait-for-push party;

a similarity calculation apparatus to obtain user group similarity information between the request-to-push party and the wait-for-push party based on the similarity weight information, the user group distinct feature information of the request-to-push party, and the user group feature information of the wait-for-push party; and

a determination apparatus to determine whether to send related push information of the request-to-push party to the wait-for-push party for pushing based on the user group similarity information.

Compared with existing technologies, the method and the device for data push according to embodiments of the present disclosure avoid interference from subjective factors by separately analyzing user-related information of target users of a request-to-push party and user information of specific users of a wait-for-push party to obtain user group distinct feature information (i.e., similarity weight information) of the request-to-push party and user group feature information of the wait-for-push party. Therefore, the user-related information can be processed quantitatively, which effectively improves intellectualization of a data push process. User group similarity information between the request-to-push party and the wait-for-push party can be effectively and quickly calculated based on the foregoing information. As a determination of whether to send related push information of the request-to-push party to the wait-for-push party for pushing is made based on the user group similarity information, the related push information of the request-to-push party can be precisely sent to the wait-for-push party for pushing. Thus, the entire data push is calculated through a scientific big data analysis, and thereby the precision and intellectualization of data push is effectively improved.

Furthermore, the method and the device for data push according to the embodiments of the present disclosure obtain user features of target users of a request-to-push party and a target group index of each of the user features based on user-related information of the target users of the request-to-push party, and pertinently determine user group distinct feature information and similarity weight information of the request-to-push party, thus leading to an accurate and precise analysis on user information of the target users of the request-to-push party. Therefore, related push information of the request-to-push party that is obtained has a good precision.

### BRIEF DESCRIPTION OF THE DRAWINGS

Features, objectives and advantages of the present disclosure will become clearer through a detailed description of non-limiting embodiments with reference to the following accompanying drawings.

FIG. 1 shows a structural diagram of an example device for data push according to the present disclosure.

FIG. 2 shows a structural diagram of example apparatuses in a device for data push according to the present disclosure.

FIG. 3 shows a structural diagram of an example device according to an embodiment of the present disclosure.

FIG. 4 shows a flowchart of an example method for data push according to the present disclosure.

FIG. 5 shows a flowchart of a method of S402 according to the present disclosure.

FIG. 6 shows a flowchart of an example method for data push according to an embodiment of the present disclosure.

Identical or similar reference labels in the accompanying drawings represent identical or similar components.

### DETAILED DESCRIPTION

The present disclosure is described in further detail hereinafter with reference to the accompanying drawings.

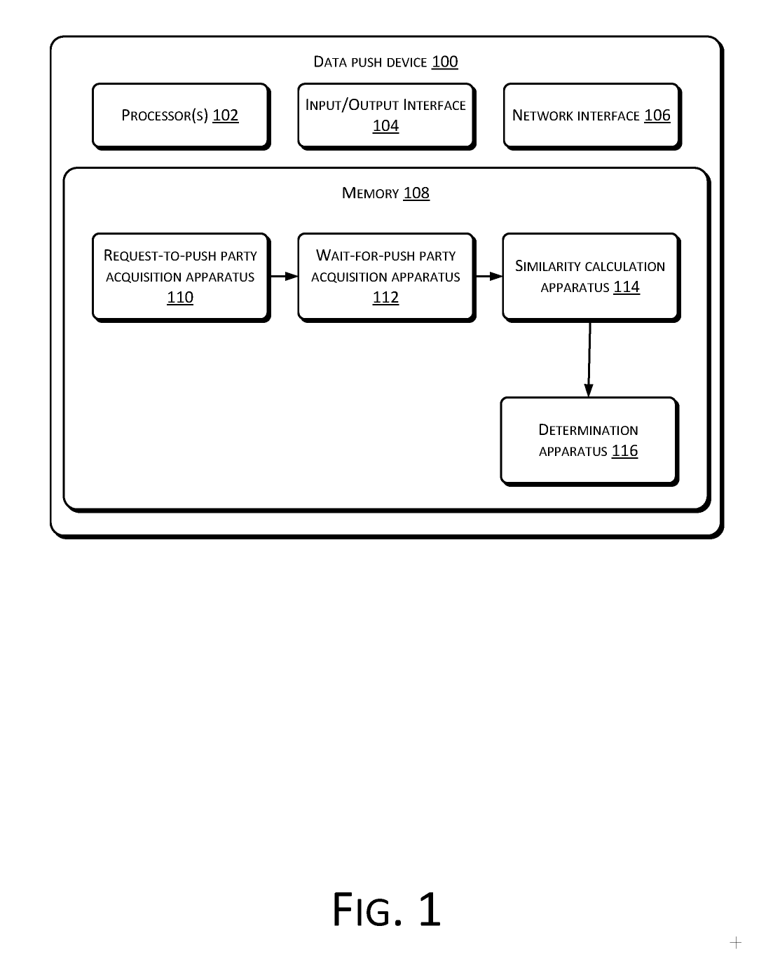

FIG. 1 shows a structural diagram illustrating a device for data push according to an aspect of the present disclosure. In implementations, a data push device 100 may include one or more computing devices. In implementations, the data push device 100 may include one or more processors 102, an input/output (I/O) interface 104, a network interface 106, and memory 108.

The memory 108 may include a form of computer-readable media, e.g., a non-permanent storage device, random-access memory (RAM) and/or a nonvolatile internal storage, such as read-only memory (ROM) or flash RAM. The memory 108 is an example of computer-readable media.

The computer-readable media may include a permanent or non-permanent type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer-readable media does not include transitory media, such as modulated data signals and carrier waves.

In implementations, the data push device 100 may include a request-to-push party acquisition apparatus 110, a wait-for-push party acquisition apparatus 112, a similarity calculation apparatus 114, and a determination apparatus 116.

In implementations, the request-to-push party acquisition apparatus 110 may obtain user-related information of target users associated with a request-to-push party, obtain user group distinct feature information about the request-to-push party based on the user-related information of the target users associated with the request-to-push party, and obtain similarity weight information of each distinct feature based on the user group distinct feature information of the request-to-push party. In implementations, the wait-for-push party acquisition apparatus 112 may obtain user-related information of specific users associated with a wait-for-push party, and obtain user group feature information of the wait-for-push party corresponding to the user group distinct feature information of the request-to-push party, based on the user-related information of the specific users associated with the wait-for-push party, where the user group distinct feature information may include distinct features and ratio information of user groups having the distinct features corresponding thereto. In implementations, the similarity calculation apparatus 114 may obtain user group similarity information between the request-to-push party and the wait-for-push party based on the similarity weight information, the user group distinct feature information of the request-to-push party, and the user group feature information of the wait-for-push party. In implementations, the determination apparatus 116 may determines whether to send related push information of the request-to-push party to the wait-for-push party for pushing based on the user group similarity information.

In implementations, the data push device 100 may include, but is not limited to, user equipment, or a device that is formed by integrating user equipment and network equipment via a network. In implementations, the user equipment may include, but is not limited to, any mobile electronic product that is able to perform human-machine interaction with a user through a touch screen, for example, a smart phone, a PDA, etc. The mobile electronic product may employ any operating system, for example, an android operating system or an iOS operating system. In implementations, the network equipment may include an electronic device that is able to automatically perform numerical computation and information processing according to a preset or stored instruction, and hardware thereof may include, but is not limited to, a microprocessor, an application-specific integrated circuit (ASIC), a field programmable gate array (FPGA), a digital signal processor (DSP), embedded equipment, etc. In implementations, the network may include, but is not limited to, the Internet, a wide area network, a metropolitan area network, a local area network, a VPN network, a wireless ad hoc network (Ad Hoc network), etc. In implementations, the device 100 may be a script program that runs on user equipment, or a combination of user equipment and network equipment, a touch terminal, or a device that is formed by integrating network equipment and a touch terminal via a network. Apparently, one skilled in the art should understand that the foregoing device 100 is merely an example. Any existing or future device 100 that is applicable to the present disclosure should also be covered in the scope of protection of the present disclosure, and is incorporated herein by reference.

The foregoing devices perform operations continuously. One skilled in the art should understand that “continuously” herein means that the foregoing devices perform operations individually in real time or according to configuration or real-time adjustment requirements of respective operation modes.

By pertinently analyzing user-related information of target users of a request-to-push party and specific users of a wait-for-push party, user group distinct feature information of the request-to-push party, similarity weight information of each distinct feature, and user group feature information of the wait-for-push party can be precisely obtained, so that user group similarity information between the request-to-push party and the wait-for-push party can be precisely obtained. Based on the user group similarity information, a determination can be effectively made for related push information of the request-to-push party to be precisely sent to the wait-for-push party for pushing, thus effectively improving the precision and intellectualization of data push.

In implementations, the request-to-push party may include at least one of an application service provider, a media service provider, or a product supplier. Being a request-to-push party, an application service provider may include a service provider that provides application software and the like. A media service provider may include a service provider of media such as TV programs, radio programs, newspapers, magazines, etc. A product provider may include a product manufacturer, a product seller, and the like. A request-to-push party may push related information (such as advertisements) of services thereof to a wait-for-push party in a form of an information push to realize promotion. Apparently, any other existing or potential request-to-push parties in the future, if applicable to the present disclosure, should also be covered in the scope of protection of the present disclosure, and are incorporated herein by reference.

In implementations, the wait-for-push party may include at least one of an application service provider, or a media service provider. As a wait-for-push party, an application service provider may include a service supplier of application software that can push related information to a user by means of pop-up information and the like, and a media service provider may include related TV programs, radio, newspapers, magazines, indoor or outdoor information displaying screens, etc., that can push information such as advertisements. In implementations, the wait-for-push party may be a TV entertainment program, a movie, a TV play program, etc., and may also be a broadcast rolling program, and the like. Apparently, any other existing or potential wait-for-push parties in the future, if applicable to the present disclosure, should also be covered in the scope of protection of the present disclosure, and are incorporated herein by reference.

In implementations, the request-to-push party acquisition apparatus 110 may be configured to obtain multiple pieces of user interaction information of the target users associated with the request-to-push party, and obtain user attribute information of the target users based on the user interaction information.

A certain e-business brand is used as an example of a request-to-push party. Data information during interaction of the e-business band is analyzed. Users (recorded as u) that have purchased or collected the e-business brand (recorded as b) in the last two months are obtained from a retail platform transaction log of the e-business brand, to form user-brand pairs, which are recorded as pairs (b, u). The user-brand pairs record user attribute information about interaction relationships between the users and the brand. Associations between the user-brand pairs and interaction information in an e-business consumer information scenario records are developed according to the users, to obtain a data set D (b, u) of respective interaction information corresponding to the user-brand pairs.

In implementations, the user attribute information may include at least one of user population attribute information, user behavior feature information, or user interest and preference information.

For example, in the foregoing embodiment of the present disclosure, the user population attribute information may include population attribute information of user(s), such as gender(s), age(s), height(s), and/or weight(s) of the user(s). The user behavior feature information may include social behavior feature information of user(s), such as social occupation(s) and working years, current income(s), and/or consumer class(es) of the user(s). The user interest information may include interest and preference information of user(s) in aspects such as sports, music, shopping, reading, and/or broadcasted entertainment programs.

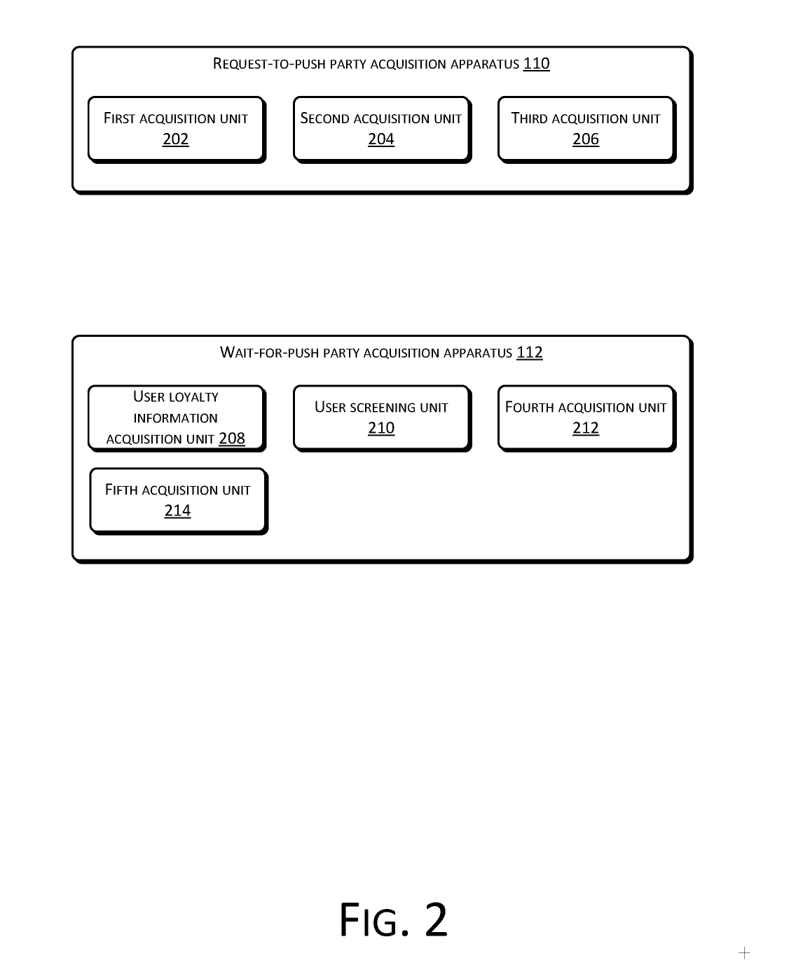

In implementations, FIG. 2 shows a structural diagram of the example apparatuses in the data push device 100 for data push according to an exemplary embodiment of the present disclosure. In implementations, the request-to-push party acquisition apparatus 110 may include a first acquisition unit 202, a second acquisition unit 204, and a third acquisition unit 206. In implementations, the first acquisition unit 202 may obtain user features of target users of a request-to-push party and target group indices of the user features based on user-related information of the target users of the request-to-push party. In implementations, a target group index may include a ratio between user group ratio information of a respective user feature in the request-to-push party and user group ratio information of the user feature in an entire user group. In implementations, the second acquisition unit 204 may select user group distinct features about the request-to-push party from the user features based on the target group indices of the user features of the request-to-push party, and obtain user group ratio information and target group indices of the user group distinct features about the request-to-push party. In implementations, the third acquisition unit 206 may obtain similarity weight information based on information of the user group distinct features of the request-to-push party. In implementations, the similarity weight information may include information about a ratio between a target group index of each user group distinct feature of the request-to-push party and a sum of the target group indices of all the user group distinct features of the request-to-push party.

In the foregoing embodiment of the present disclosure, the first acquisition unit 202 obtains all user features of the target users of the e-business brand, which may include, for example, respective ages, genders, occupations, current incomes, etc., and calculates a TGI (i.e., Target Group Index) of each user feature based on an attribute value (which is recorded as v) of each discrete user feature in the user-related information of the target users. For example, a TGI of an attribute value v of a user feature “age” of a target user b, which is recorded as TGI (b, v), where TGI (b, v)=a group index that is calculated as a percentage of groups having the attribute value v among groups interacting with the e-business brand/an interaction data set D (b, u) that has the attribute value v and corresponds to all user features interacting with the e-business brand. For example, in a target user population at ages of 18 to 26, 95% of target users have interaction information of purchase or collection activities with the e-business brand b, while 78% of the total population has interaction information of purchase or collection activities with the e-business brand b. In this case, a target group index TGI of the e-business brand b in the target user population at the ages of 18 to 26=95%/78%=121.8%. For another example, in a target user population of which the user feature is “female”, 67% of target users have interaction information of purchase or collection activities with the e-business brand b, and 35% of the total population has interaction information of purchase or collection activities with the e-business brand b. In this case, the e-business brand b in the target user population of which the user feature is “female” has a target group index TGI=67%/35%=191.4%. For another instance, in a target user population of which the user feature is “white collar”, 88% of target users have interaction information of purchase or collection activities with the e-business brand b, while 54% of the total population has interaction information of purchase or collection activities with the e-business brand b. In this case, the e-business brand b in the target user population of which the user feature is “white collar” has a target group index TGI=88%/54%=163.0%.

In implementations, the second acquisition unit 204 may be configured to determine a user feature of the request-to-push party as a user group distinct feature when a target group index of the user feature is higher than an index threshold, and obtain the group ratio information and the target group indices of the user group distinct features about the request-to-push party.

It should be noted that an example index threshold in the foregoing embodiment of the present disclosure may be “1”. In other words, when a target group index TGI of a user feature of the request-to-push party is higher than “1”, the user feature is determined as a user group distinct feature. Apparently, any other existing or potential index thresholds in the future, if applicable to the present disclosure, should also be covered in the scope of protection of the present disclosure, and are incorporated herein by reference.

In the foregoing embodiment of the present disclosure, since the target group index TGI of the target user population at the ages of 18 to 16 is 121.8%, which is higher than “1”, the user feature “the ages of 18 to 26” is determined as a user group distinct feature. Since the target group index TGI of the “female” target user population is 191.4%, the user feature “female” is determined as a user group distinct feature. Since the target group index TGI of the “white collar” target user population is 163.0%, the user feature “white collar” is determined as a user group distinct feature.

In the foregoing embodiment of the present disclosure, based on the user group distinct features, user group ratio information of all user group distinct features is obtained, which is recorded as:

$${f}_{bi} = \frac{{count}_{b} ( {v}_{i} )}{{count}_{b}} ,$$

wherein count_{b}(vᵢ) represents the number of feature vᵢ in an interaction population of an e-business brand b, and count_{b} represents the size of population of the e-business brand b. For example, the total number of population having interaction information with the e-business brand b is 100, and the number of target users having a user group distinct feature as “ages of 18 to 26” in an interaction population of the e-business brand b is 95. In this case, ratio information of a user group with the user group distinct feature of “the ages of 18 to 26” is determined to be f_{b1}=95%. The number of target users whose user group distinct feature is “female” in the interaction population of the e-business brand b is 67. In this case, ratio information of a user group with the user group distinct feature of “female” is f_{b2}=67%. The number of target users whose user group distinct feature is “white collar” in the interaction population of the e-business brand b is 88. In this case, ratio information of a user group with the user group distinct feature of “white collar” is f_{b3}=88%.

In the foregoing embodiment of the present disclosure, based on the user group distinct features and the user group ratio information, user group distinct feature information corresponding to the e-business brand b is obtained, which is recorded as: vector_{b}= [symbol] f_{b1}, f_{b2}, . . . , f_{bn} [symbol] , which represents vector information constructed from percentages of n pieces of user group ratio information corresponding to target users interacting with the e-business brand b. For example, the vector information constructed from user group ratio information corresponding to the target users interacting with the e-business brand b is vector_{b}= [symbol] f_{b1}, f_{b2}, f_{b3} [symbol] = [symbol] 95%, 67%, 88% [symbol] .

In implementations, the third acquisition unit 206 obtains the similarity weight information based on the user group distinct feature information of the request-to-push party. It should be noted that, in the foregoing embodiment of the present disclosure, the similarity weight information may be obtained using the following formula:

$${W}_{i} = \frac{T G I ( b , {v}_{i} )}{{\sum }_{i = 1}^{n} T G I ( b , {v}_{i} )} .$$

Apparently, any other existing or possible algorithms in the future for obtaining the similarity weight information, if applicable to the present disclosure, should also be covered in the scope of protection of the present disclosure, and are incorporated herein by reference.

For example, the user group distinct features of the e-business brand b are v₁ “ages of 18 to 26”, v₂ “female” and v₃ “white collar”, and the target group index TGI of the feature vᵢ is TGI (b, vᵢ). In this case, similarity weight information W₁ of the user group distinct feature v₁ is:

$${W}_{1} = \frac{T G I ( b , {v}_{1} )}{{\sum }_{i = 1}^{3} T G I ( b , {v}_{i} )} = \frac{95 \%}{95 \% + 67 \% + 88 \%} = 38 \% .$$

Similarity weight information W₂ of the user group distinct feature v₂ is:

$${W}_{2} = \frac{T G I ( b , {v}_{2} )}{{\sum }_{i = 1}^{3} T G I ( b , {v}_{i} )} = \frac{67 \%}{95 \% + 67 \% + 88 \%} = 26.8 \% .$$

And, similarity weight information W₃ of the user group distinct feature v₃ is:

$${W}_{3} = \frac{T G I ( b , {v}_{3} )}{{\sum }_{i = 1}^{3} T G I ( b , {v}_{i} )} = \frac{88 \%}{95 \% + 67 \% + 88 \%} = 35.2 \% .$$

Furthermore, the wait-for-push party acquisition apparatus 112 obtains user-related information of specific users of a wait-for-push party, and obtains user group feature information about the wait-for-push party based on the user-related information of the specific users of the wait-for-push party. In implementations, the user group feature information of the wait-for-push party may include features of the wait-for-push party and ratio information of user groups having the corresponding features. The features are selected based on the distinct features in the user group distinct feature information of the request-to-push party, i.e., corresponding to the distinct features in the user group distinct feature information of the request-to-push party.

In implementations, the wait-for-push party acquisition apparatus 112 may include a user loyalty information acquisition unit 208 and a user screening unit 210. The user loyalty information acquisition unit 208 may obtain user loyalty information of the wait-for-push party based on the user-related information of the specific users of the wait-for-push party. The user screening unit 210 screens the user-related information of the specific users of the wait-for-push party based on the user loyalty information.

A TV program is used hereinafter as an example of a wait-for-push party. User-related information of specific users obtained by the wait-for-push party may include interaction data information between the specific users and the TV program, and relationship information of binding between the specific users and the TV program. For example, a watching data set of a number of specific users for a TV program is first obtained. Data of watching the TV program is mainly obtained through an intelligent TV log acquisition system, which collects a mac address of each TV set, a mac address of a home router, information of a watched program, a watching time, and a watching duration, and interconnects with the TV program and a family member id with an assistance of a family information bridge (FIB) service. A format of watching data after acquisition and interconnection is a format of watching data of a TV program by a specific user, as shown in Table 1.

TABLE 1
A format of watching data of a TV program by a specific user

| Field name | Data type | Description |
|---|---|---|
| user_id | string | user id, which is a family user natural person id |
| | | that is converted from a TV id according to a |
| | | FIB service |
| epg_ca_id | string | abstract program id (an id for a program |
| | | of a TV station) |
| start_time | string | watching start time, in a format of |
| | | yyyy-mm-dd hh:mi:ss |
| end_time | string | watching end time, in a format of |
| | | yyyy-mm-dd hh:mi:ss |
| dt | string | date (distinguishing field) |

A data format of program meta-information data of a TV program that is collected is shown in Table 2.

In the foregoing embodiment of the present disclosure, in order to better represent the program using the user group features, noise programs, that is, non-loyal program users, need to be removed by filtering. The user loyalty information acquisition unit 208 obtains user loyalty information of the wait-for-push party based on the user-related information of the specific users of the wait-for-push party.

TABLE 2
A data format of program meta-information data of a TV program

| Field name | Data type | Description |
|---|---|---|
| epg_ca_id | string | abstract program id (an id for a program of a |
| | | TV station) |
| epg_ca_name | string | abstract program name |
| start_time | string | watching start time, in a format of |
| | | yyyy-mm-dd hh:mi:ss |
| end_time | string | watching end time, in a format of |
| | | yyyy-mm-dd hh:mi:ss |
| dt | string | date (distinguishing field) |

In implementations, the user loyalty information may include at least one of a frequency of interaction, a time duration of single interaction, a total time duration of interaction, an average time duration of interaction, or a last valid interaction time between a specific user and the wait-for-push party.

For example, programs having a playing frequency greater than 2 and a time duration of each play longer than 10 minutes are firstly extracted from program meta-information data set of TV programs collected in the last 2 months. Then, the number of days from a latest date, on which a specific user (recorded as u) watches each TV program (recorded as e) for more than 1 minute, to the current date, that is, the last valid interaction time, is calculated and recorded as r (u, e). The number of days on which the specific user watches each TV program, that is, the total time duration of interaction, is calculated and recorded as f (u, e). The average minutes of time for which the user watches each TV program each time per day, that is, the single time duration of interaction, is calculated and recorded as: m (u, e). Then, respective average number-of-day differences of watching each TV program, average time durations of interaction, and average frequencies of interaction of all specific users are calculated separately, which are recorded as avg_r (e), avg_f (e), and avg_m (e) respectively. Finally, a difference between r (u, e) and avg_r (e), a difference between f (u, e) and avg_f (e), and a difference between m (u, e) and avg_m (e) are calculated separately, which are recorded as rd (u, e), fd (u, e), and md (u, e) respectively.

In implementations, the user screening unit 210 may be configured to compare user loyalty information of a specific user of the wait-for-push party with average user loyalty information of all the specific users of the wait-for-push party, and keep the user-related information of the specific user if a comparison result thereof meets a loyalty condition.

It should be noted that, in the foregoing embodiment of the present disclosure, an exemplary loyalty condition may include “rd (u, e) less than 0, fd (u, e) greater than 0, and and (u, e) greater than 0”. In other words, when a last time duration of interaction of a specific user of the wait-for-push party is less than an average number-of-day difference of last watching by all the specific users, a total time duration of interaction of the specific user is longer than an average time duration of interaction of all the specific users, and a single time duration of interaction of the specific user is longer than an average frequency of interaction of all the specific users, user-related information of the specific user is maintained, and the specific user is determined as a loyal user of an associated TV program, to facilitate acquisition of user features of the specific user and a target group index of each of the user features. Apparently, any other existing or possible loyalty conditions in the future, if applicable to the present disclosure, should also be covered in the scope of protection of the present disclosure, and are incorporated herein by reference.

In implementations, the wait-for-push party acquisition apparatus 112 may further include a fourth acquisition unit 212 and a fifth acquisition unit 214. The fourth acquisition unit 212 obtains the user group distinct feature information of the request-to-push party. The fifth acquisition unit 214 obtains user features of the wait-for-push party and a target group index of each of the user features from the user-related information of the specific users of the wait-for-push party, based on the distinct features in the user group distinct feature information of the request-to-push party. In implementations, the user features of the wait-for-push party correspond to the distinct features of the request-to-push party, and the target group index includes a ratio between group ratio information of each of the user features in the wait-for-push party and group ratio information of the user feature in a total group. In implementations, the fifth acquisition unit 214 may select user group distinct features about the wait-for-push party from the user features based on the target group indices of the user features of the wait-for-push party, and obtain group ratio information and target group indices of the user group distinct features about the wait-for-push party.

In the foregoing embodiment of the present disclosure, the fourth acquisition unit 212 obtains the user group distinct feature information of the request-to-push party. For example, user group distinct feature information of a brand may include corresponding age, gender, occupation, ordinary income, and the like. The fifth acquisition unit 214 obtains user features of specific users who meet the foregoing loyalty condition(s) of the wait-for-push party for a TV program, which may include age, gender, occupation, ordinary income, etc., based on the user group distinct feature information of the brand, and calculates a TGI′ (Target Group Index) of each specific user feature based on an attribute value (which is recorded as v) of each discrete user feature in user-related information of the specific users. TGI′ of an attribute value v of a user feature “age” of a specific user e of a TV program is recorded as TGI′ (e, v), where TGI′ (e, v)=a group index that is calculated as a percentage of groups having the attribute value v from among groups interacting with the TV program/an interaction data set D′ (e, v) that has the attribute value v and corresponds to all user features interacting with the TV program. For example, user group distinct features of the TV program may include ages of 18 to 26, female, and white collar. In this case, related information of these three user features—ages of 18 to 26, female, and white collar—in respective specific populations is calculated. In a specific user population of ages of 18 to 26, 92% of specific users have interaction information of watching or buffering activities with the TV program e, while 70% of the total population has interaction information of watching or buffering activities with the TV program e. In this case, the TV program e in the specific user population of the ages of 18 to 26 has a target group index TGI′=92%/70%=131.4%. For another example, in a specific user population of the user feature “female”, 68% of specific users have interaction information of watching or buffering activities with the TV program e, while 40% of the total population has interaction information of watching or buffering activities with the TV program e. In this case, the TV program e in the specific user population of the user feature “female” has a target group index TGI′=68%/40%=170.0%. For another example, in a specific user population of the user feature “white collar”, 90% of specific users have interaction information of watching or buffering activities with the TV program e, while 52% of the total population has interaction information of watching or buffering activities with the TV program e. In this case, the TV program e in the specific user population of the user feature “female” has a target group index TGI′=90%/52%=173.1%.

In the foregoing embodiment of the present disclosure, the user group ratio information of all user group features is obtained based on the user group features, which is recorded as:

$${f}_{ei} = \frac{{count}_{e} ( {v}_{i} )}{{count}_{e}} ,$$

wherein countₑ(vᵢ) represents the number of feature vᵢ in an interaction population of a TV program e, and countₑ represents the size of population watching the TV program e. For example, the total size of population having interaction information with the TV program e is 100, and the number of specific users having the user group feature as “ages of 18 to 26” in the interaction population of the TV program e is 92. In this case, ratio information of the user group with the user group distinct feature “ages of 18 to 26” is determined to be fₑ₁=92%. The number of specific users having a user group distinct feature s “female” in the interaction population of the TV program e is 68. In this case, ratio information of the user group with the user group distinct feature “female” is determined to be fₑ₂=68%. The number of specific users having a user group distinct feature s “white collar” in the interaction population of the TV program e is 90. In this case, ratio information of the user group with the user group distinct feature “white collar” is determined to be fₑ₃=90%.

In the foregoing embodiment of the present disclosure, user group feature information corresponding to the TV program e is obtained based on the user group features and the user group ratio information, which is recorded as:

vectorₑ= [symbol] fₑ₁,fₑ₂, . . . fₑₙ [symbol] ,

which represents vector information constructed from percentages of n pieces of user group ratio information corresponding to specific users interacting with the TV program e. For example, the vector information constructed from the user group ratio information corresponding to the specific users interacting with the TV program e is:

vector_{b}= [symbol] fₑ₁,fₑ₂,fₑ₃ [symbol] = [symbol] 92%,68%,90% [symbol] .

In implementations, the similarity calculation apparatus 114 may be configured to calculate a degree of similarity to obtain the user similarity information between the request-to-push party and the wait-for-push party, based on user group ratio information of each distinct feature that is identical in respective user group feature information of the request-to-push party and the wait-for-push party, and corresponding similarity weight information.

In the foregoing embodiment of the present disclosure, the user similarity information between the e-business brand and the TV program is obtained based on count_{b} of the e-business brand, countₑ of the TV program, and the similarity weight information Wi of each user group distinct feature vᵢ using a weighted Euclidean distance algorithm. In implementations, the algorithm may include:

$$d ( {vector}_{b} , {vector}_{e} ) = \sqrt{{w}_{1} {\vert {f}_{b 1} - {f}_{e 1} \vert}^{2} + {w}_{2} {\vert {f}_{b 2} - {f}_{e 2} \vert}^{2} + … + {w}_{n} {\vert {f}_{bn} - {f}_{en} \vert}^{2} } .$$

It should be noted that, in the foregoing embodiment of the present disclosure, the example weighted Euclidean distance algorithm for calculating user similarity information is merely an exemplary embodiment of the present disclosure. Apparently, other existing or possible algorithms in the future that is able to calculate user similarity information, if applicable to the present disclosure, should also be covered in the scope of protection of the present disclosure, and are incorporated herein by reference.

Continuing with the foregoing example, the user similarity information between the e-business brand b and the TV program e, which is obtained based on count_{b} of the e-business brand, countₑ of the TV program, and the similarity weight information Wᵢ of each user group distinct feature vᵢ, is shown as follows:

$$\begin{matrix}d ( {vector}_{b} , {vector}_{e} ) = \sqrt{\begin{matrix}{w}_{1} {\vert {f}_{b 1} - {f}_{e 1} \vert}^{2} + {w}_{2} {\vert {f}_{b 2} - {f}_{e 2} \vert}^{2} + … + \\ {w}_{n} {\vert {f}_{bn} - {f}_{en} \vert}^{2}\end{matrix}} \\ = \sqrt{\begin{matrix}38 \% {\vert 95 \% - 92 \% \vert}^{2} + 26.8 \% {\vert 67 \% - 68 \% \vert}^{2} + \\ 35.2 \% {\vert 88 \% - 90 \% \vert}^{2}\end{matrix}} \\ = 0.022 .\end{matrix}$$

In implementations, the determination apparatus 116 may determines whether to send the related push information of the request-to-push party to the wait-for-push party for pushing based on a relationship between the user similarity information and a user similarity threshold.

It should be noted that, in the foregoing embodiment of the present disclosure, an example user similarity threshold may be determined based on the capital of the request-to-push party or the precision of the request-to-push party. The user similarity threshold is set s “0.5” as an example herein. Specifically, when the user similarity information is lower than the set user similarity threshold “0.5”, the related push information of the request-to-push party is sent to the wait-for-push party for pushing. Otherwise, the related push information of the request-to-push party is not allowed to be sent the wait-for-push party for pushing. Apparently, other existing or possible methods in the future for setting the user similarity threshold, if applicable to the present disclosure, should also be covered in the scope of protection of the present disclosure, and are incorporated herein by reference.

In implementations, the determination apparatus 116 may be configured to obtain push priority order information of the wait-for-push party based on the user similarity information; and determine whether to send the related push information of the request-to-push party to the wait-for-push party for pushing based on the push priority order information of the wait-for-push party.

For example, in the foregoing embodiment of the present disclosure, user similarity information <d1, d2, d3 . . . dn> between an e-business brand b and a number of candidate TV programs is obtained. Program push priority order information of the candidate TV programs is obtained based on <d1, d2, d3 . . . dn>. If the program push priority order information of the candidate TV programs is <d3, d6, d7, d10, d11, d1, d4, d2 . . . > in a descending order, that TV programs which user similarity information is ranked in the top three positions are determined to be used as wait-for-push parties <d3, d6, d7> based on respective capitals of the request-to-push parties or respective precisions of the request-to-push parties, and related push information of the e-business brand b is sent to the wait-for-push parties <d3, d6, d7> for pushing.

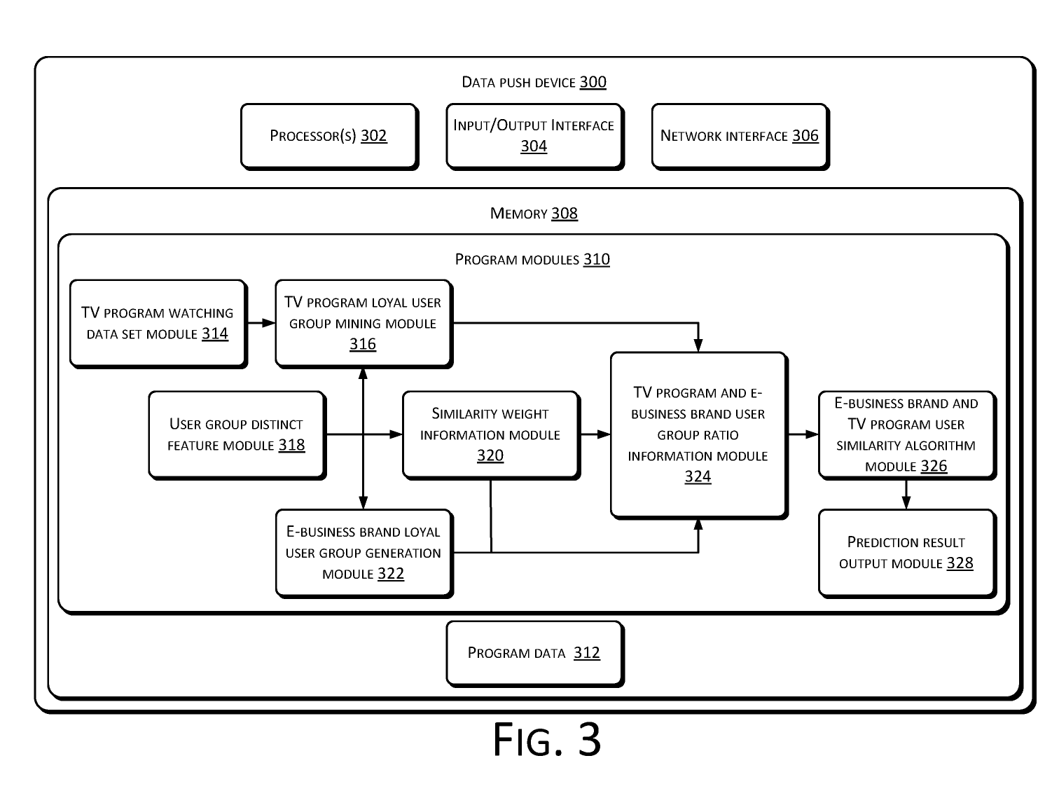

FIG. 3 shows a structural diagram of a data push device 300 for data push according to an exemplary embodiment of the present disclosure. By way of example and not limitation, the data push device 300 may include one or more computing devices. In implementations, the data push device 300 may include one or more processors 302, an input/output interface 304, a network interface 306, and memory 308. The memory 308 may include one or more computer-readable media as described in the foregoing descriptions.

In implementations, the memory 308 may include program modules 310 and program data 312. The program module 310 may include a TV program watching data set module 314, a TV program loyal user group mining module 316, a user group distinct feature module 318, a similarity weight information module 320, an e-business brand loyal user group generation module 322, a TV program and e-business brand user group ratio information module 324, an e-business brand and TV program user similarity algorithm module 326, and a prediction result output module 328.

In the foregoing embodiment of the present disclosure, the TV program watching data set module 314 obtains user-related information of specific users having an interaction relationship with a TV program. Based on the obtained user-related information, the TV program loyal user group mining module 316 mines and obtains specific user(s) meeting a loyalty condition to serve as loyal users of the TV program. Furthermore, the user group distinct feature module 318 obtains user group feature information of the specific users of the TV program. The user group feature information may include features of the specific users of the TV program and ratio information of user groups having the corresponding features. In implementations, the features are selected based on distinct features in user group distinct feature information of an e-business brand, i.e., corresponding to distinct features in user group distinct feature information of a request-to-push party.

In implementations, the e-business brand loyal user group generation module 322 may obtain interaction information of target users interacting with the e-business brand, and the user group distinct feature module 318 may obtain user group distinct feature information of the target users of the e-business brand. Based on the user group distinct feature information of the target users of the e-business brand, the similarity weight information module 320 obtains similarity weight information. Through the TV program loyal user group mining module 316, the user group distinct feature module 318, and the e-business brand loyal user group generation module 322, user group ratio information of the TV program and user group ratio information of the e-business brand are obtained by the TV program and e-business brand user group ratio information module 324. Through the similarity weight information module 320 and the TV program and e-business brand user group ratio information module 324, user group similarity information between the e-business brand and the TV program is calculated by the e-business brand and TV program user similarity algorithm module 326 using a similarity algorithm. In implementations, the prediction result output module 328 may determine whether to send the related push information of the request-to-push party to the wait-for-push party for pushing based on a relationship between the user similarity information and a user similarity threshold, thus precisely determining to send the related push information of the request-to-push party to a corresponding wait-for-push party which meets a condition for pushing. As such, the entire data push process is calculated via scientific big data analysis, and thereby precision and intellectualization of data push is improved more effectively.

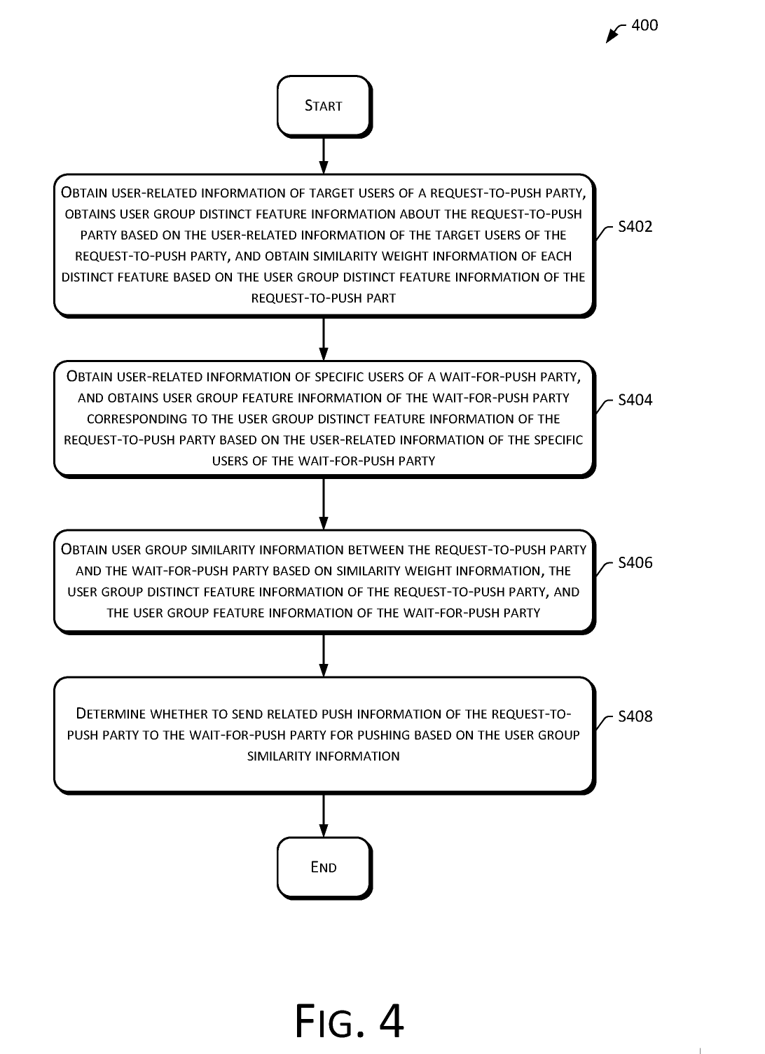

FIG. 4 shows a flowchart of a method 400 for data push according to another aspect of the present disclosure. In implementations, the method 400 may include S402, S404, S406, and S408.

S402 obtains user-related information of target users of a request-to-push party, obtains user group distinct feature information about the request-to-push party based on the user-related information of the target users of the request-to-push party, and obtains similarity weight information of each distinct feature based on the user group distinct feature information of the request-to-push party, where the user group distinct feature information includes distinct features and ratio information of user groups having the corresponding distinct features.

S404 obtains user-related information of specific users of a wait-for-push party, and obtains user group feature information of the wait-for-push party corresponding to the user group distinct feature information of the request-to-push party based on the user-related information of the specific users of the wait-for-push party.

S406 obtains user group similarity information between the request-to-push party and the wait-for-push party based on similarity weight information, the user group distinct feature information of the request-to-push party, and the user group feature information of the wait-for-push party.

S408 determines whether to send related push information of the request-to-push party to the wait-for-push party for pushing based on the user group similarity information.

In implementations, the request-to-push party may include at least one of an application service provider, a media service provider, or a product supplier. Being a request-to-push party, an application service provider may include a service provider that provides application software and the like. A media service provider may include a service provider of media such as TV programs, radio programs, newspapers, magazines, etc. A product provider may include a product manufacturer, a product seller, and the like. A request-to-push party may push related information (such as advertisements) of services thereof to a wait-for-push party in a form of an information push to realize promotion. Apparently, any other existing or potential request-to-push parties in the future, if applicable to the present disclosure, should also be covered in the scope of protection of the present disclosure, and are incorporated herein by reference.

In implementations, the wait-for-push party may include at least one of an application service provider, or a media service provider. As a wait-for-push party, an application service provider may include a service supplier of application software that can push related information to a user by means of pop-up information and the like, and a media service provider may include related TV programs, radio, newspapers, magazines, indoor or outdoor information displaying screens, etc., that can push information such as advertisements. In implementations, the wait-for-push party may be a TV entertainment program, a movie, a TV play program, etc., and may also be a broadcast rolling program, and the like. Apparently, any other existing or potential wait-for-push parties in the future, if applicable to the present disclosure, should also be covered in the scope of protection of the present disclosure, and are incorporated herein by reference.

Specifically, S402 obtains the user-related information of the target users of the request-to-push party, obtains the user group distinct feature information about the request-to-push party based on the user-related information of the target users of the request-to-push party, and obtains the similarity weight information of each distinct feature based on the user group distinct feature information of the request-to-push party. The user group distinct feature information includes the distinct features and the ratio information of user groups having the corresponding distinct features.

In implementations, S402 may further obtain multiple pieces of user interaction information of the target users associated with the request-to-push party, and obtain user attribute information of the target users based on the user interaction information.

A certain e-business brand is used as an example of a request-to-push party. Data information during interaction of the e-business band is analyzed. Users (recorded as u) that have purchased or collected the e-business brand (recorded as b) in the last two months are obtained from a retail platform transaction log of the e-business brand, to form user-brand pairs, which are recorded as pairs (b, u). The user-brand pairs record user attribute information about interaction relationships between the users and the brand. Associations between the user-brand pairs and interaction information in an e-business consumer information scenario records are developed according to the users, to obtain a data set D (b, u) of respective interaction information corresponding to the user-brand pairs.

In implementations, the user attribute information may include at least one of user population attribute information, user behavior feature information, or user interest and preference information.

For example, in the foregoing embodiment of the present disclosure, the user population attribute information may include population attribute information of user(s), such as gender(s), age(s), height(s), and/or weight(s) of the user(s). The user behavior feature information may include social behavior feature information of user(s), such as social occupation(s) and working years, current income(s), and/or consumer class(es) of the user(s). The user interest information may include interest and preference information of user(s) in aspects such as sports, music, shopping, reading, and/or broadcasted entertainment programs.

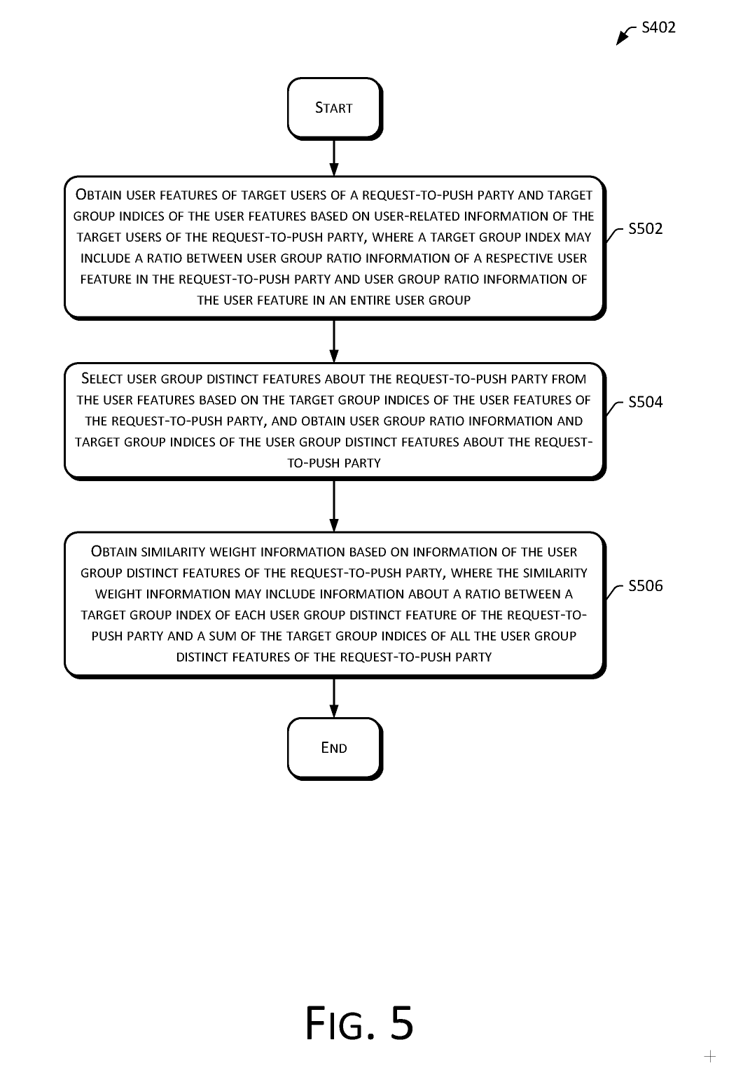

In implementations, FIG. 5 shows a flowchart of the operation S402 according to an exemplary embodiment of the present disclosure. In implementations, the operation S402 may include S502, S504, and S506. In implementations, S502 obtains user features of target users of a request-to-push party and target group indices of the user features based on user-related information of the target users of the request-to-push party. In implementations, a target group index may include a ratio between user group ratio information of a respective user feature in the request-to-push party and user group ratio information of the user feature in an entire user group. S504 selects user group distinct features about the request-to-push party from the user features based on the target group indices of the user features of the request-to-push party, and obtains user group ratio information and target group indices of the user group distinct features about the request-to-push party. S506 obtains similarity weight information based on information of the user group distinct features of the request-to-push party. In implementations, the similarity weight information may include information about a ratio between a target group index of each user group distinct feature of the request-to-push party and a sum of the target group indices of all the user group distinct features of the request-to-push party.

In the foregoing embodiment of the present disclosure, the operation S502 obtains all user features of the target users of the e-business brand, which may include, for example, respective ages, genders, occupations, current incomes, etc., and calculates a TGI (i.e., Target Group Index) of each user feature based on an attribute value (which is recorded as v) of each discrete user feature in the user-related information of the target users. For example, a TGI of an attribute value v of a user feature “age” of a target user b, which is recorded as TGI (b, v), where TGI (b, v)=a group index that is calculated as a percentage of groups having the attribute value v among groups interacting with the e-business brand/an interaction data set D (b, u) that has the attribute value v and corresponds to all user features interacting with the e-business brand. For example, in a target user population at ages of 18 to 26, 95% of target users have interaction information of purchase or collection activities with the e-business brand b, while 78% of the total population has interaction information of purchase or collection activities with the e-business brand b. In this case, a target group index TGI of the e-business brand b in the target user population at the ages of 18 to 26=95%/78%=121.8%. For another example, in a target user population of which the user feature is “female”, 67% of target users have interaction information of purchase or collection activities with the e-business brand b, and 35% of the total population has interaction information of purchase or collection activities with the e-business brand b. In this case, the e-business brand b in the target user population of which the user feature is “female” has a target group index TGI=67%/35%=191.4%. For another instance, in a target user population of which the user feature is “white collar”, 88% of target users have interaction information of purchase or collection activities with the e-business brand b, while 54% of the total population has interaction information of purchase or collection activities with the e-business brand b. In this case, the e-business brand b in the target user population of which the user feature is “white collar” has a target group index TGI=88%/54%=163.0%.

In implementations, the operation S504 may determine a user feature of the request-to-push party as a user group distinct feature when a target group index of the user feature is higher than an index threshold, and obtain the group ratio information and the target group indices of the user group distinct features about the request-to-push party.

It should be noted that an example index threshold in the foregoing embodiment of the present disclosure may be “1”. In other words, when a target group index TGI of a user feature of the request-to-push party is higher than “1”, the user feature is determined as a user group distinct feature. Apparently, any other existing or potential index thresholds in the future, if applicable to the present disclosure, should also be covered in the scope of protection of the present disclosure, and are incorporated herein by reference.

In the foregoing embodiment of the present disclosure, since the target group index TGI of the target user population at the ages of 18 to 16 is 121.8%, which is higher than “1”, the user feature “the ages of 18 to 26” is determined as a user group distinct feature. Since the target group index TGI of the “female” target user population is 191.4%, the user feature “female” is determined as a user group distinct feature. Since the target group index TGI of the “white collar” target user population is 163.0%, the user feature “white collar” is determined as a user group distinct feature.

In the foregoing embodiment of the present disclosure, based on the user group distinct features, user group ratio information of all user group distinct features is obtained, which is recorded as:

$${f}_{bi} = \frac{{count}_{b} ( {v}_{i} )}{{count}_{b}} ,$$

wherein count_{b}(vᵢ) represents the number of feature vᵢ in an interaction population of an e-business brand b, and count_{b} represents the size of population of the e-business brand b. For example, the total number of population having interaction information with the e-business brand b is 100, and the number of target users having a user group distinct feature as “ages of 18 to 26” in an interaction population of the e-business brand b is 95. In this case, ratio information of a user group with the user group distinct feature of “the ages of 18 to 26” is determined to be f_{b1}=95%. The number of target users whose user group distinct feature is “female” in the interaction population of the e-business brand b is 67. In this case, ratio information of a user group with the user group distinct feature of “female” is f_{b2}=67%. The number of target users whose user group distinct feature is “white collar” in the interaction population of the e-business brand b is 88. In this case, ratio information of a user group with the user group distinct feature of “white collar” is f_{b3}=88%.

In the foregoing embodiment of the present disclosure, based on the user group distinct features and the user group ratio information, user group distinct feature information corresponding to the e-business brand b is obtained, which is recorded as: vector_{b}= [symbol] f_{b1}, f_{b2}, . . . , f_{bn} [symbol] , which represents vector information constructed from percentages of n pieces of user group ratio information corresponding to target users interacting with the e-business brand b. For example, the vector information constructed from user group ratio information corresponding to the target users interacting with the e-business brand b is vector_{b}= [symbol] f_{b1}, f_{b2}, f_{b3} [symbol] = [symbol] 95%, 67%, 88% [symbol] .

In implementations, the third acquisition unit 206 obtains the similarity weight information based on the user group distinct feature information of the request-to-push party. It should be noted that, in the foregoing embodiment of the present disclosure, the similarity weight information may be obtained using the following formula:

$${W}_{i} = \frac{T G I ( b , {v}_{i} )}{{\sum }_{i = 1}^{n} T G I ( b , {v}_{i} )} .$$

Apparently, any other existing or possible algorithms in the future for obtaining the similarity weight information, if applicable to the present disclosure, should also be covered in the scope of protection of the present disclosure, and are incorporated herein by reference.

For example, the user group distinct features of the e-business brand b are v₁ “ages of 18 to 26”, v₂ “female” and v₃ “white collar”, and the target group index TGI of the feature vᵢ is TGI (b, vᵢ). In this case, similarity weight information W₁ of the user group distinct feature v₁ is:

$${W}_{1} = \frac{T G I ( b , {v}_{1} )}{{\sum }_{i = 1}^{3} T G I ( b , {v}_{i} )} = \frac{95 \%}{95 \% + 67 \% + 88 \%} = 38 \% .$$

Similarity weight information W₂ of the user group distinct feature v₂ is:

$${W}_{2} = \frac{T G I ( b , {v}_{2} )}{{\sum }_{i = 1}^{3} T G I ( b , {v}_{i} )} = \frac{67 \%}{95 \% + 67 \% + 88 \%} = 26.8 \% .$$

And, similarity weight information W₃ of the user group distinct feature v₃ is:

$${W}_{3} = \frac{T G I ( b , {v}_{3} )}{{\sum }_{i = 1}^{3} T G I ( b , {v}_{i} )} = \frac{88 \%}{95 \% + 67 \% + 88 \%} = 35.2 \% .$$

Furthermore, the operation S404 may obtain user-related information of specific users of a wait-for-push party, and obtain user group feature information about the wait-for-push party based on the user-related information of the specific users of the wait-for-push party.

In implementations, S404 may further obtain user loyalty information of the wait-for-push party based on the user-related information of the specific users of the wait-for-push party, and screen the user-related information of the specific users of the wait-for-push party based on the user loyalty information.

A TV program is used hereinafter as an example of a wait-for-push party. User-related information of specific users obtained by the wait-for-push party may include interaction data information between the specific users and the TV program, and relationship information of binding between the specific users and the TV program. For example, a watching data set of a number of specific users for a TV program is first obtained. Data of watching the TV program is mainly obtained through an intelligent TV log acquisition system, which collects a mac address of each TV set, a mac address of a home router, information of a watched program, a watching time, and a watching duration, and interconnects with the TV program and a family member id with an assistance of a family information bridge (FIB) service. A format of watching data after acquisition and interconnection is a format of watching data of a TV program by a specific user, as shown in Table 1 in the foregoing embodiment of the present disclosure.

A data format of program meta-information data of a TV program that is collected is shown in Table 2 of the foregoing embodiment of the present disclosure.

In the foregoing embodiment of the present disclosure, in order to better represent the program using the user group features, noise programs, that is, non-loyal program users, need to be removed by filtering. The user loyalty information acquisition unit 208 obtains user loyalty information of the wait-for-push party based on the user-related information of the specific users of the wait-for-push party.

In implementations, the user loyalty information may include at least one of a frequency of interaction, a time duration of single interaction, a total time duration of interaction, an average time duration of interaction, or a last valid interaction time between a specific user and the wait-for-push party.

For example, programs having a playing frequency greater than 2 and a time duration of each play longer than 10 minutes are firstly extracted from program meta-information data set of TV programs collected in the last 2 months. Then, the number of days from a latest date, on which a specific user (recorded as u) watches each TV program (recorded as e) for more than 1 minute, to the current date, that is, the last valid interaction time, is calculated and recorded as r (u, e). The number of days on which the specific user watches each TV program, that is, the total time duration of interaction, is calculated and recorded as f (u, e). The average minutes of time for which the user watches each TV program each time per day, that is, the single time duration of interaction, is calculated and recorded as: m (u, e). Then, respective average number-of-day differences of watching each TV program, average time durations of interaction, and average frequencies of interaction of all specific users are calculated separately, which are recorded as avg_r (e), avg_f (e), and avg_m (e) respectively. Finally, a difference between r (u, e) and avg_r (e), a difference between f (u, e) and avg_f (e), and a difference between m (u, e) and avg_m (e) are calculated separately, which are recorded as rd (u, e), fd (u, e), and md (u, e) respectively.

In implementations, screening the user-related information of the specific users of the wait-for-push party may include comparing user loyalty information of a specific user of the wait-for-push party with average user loyalty information of all the specific users of the wait-for-push party, and keeping the user-related information of the specific user if a comparison result thereof meets a loyalty condition.

It should be noted that, in the foregoing embodiment of the present disclosure, an exemplary loyalty condition may include “rd (u, e) less than 0, fd (u, e) greater than 0, and md (u, e) greater than 0”. In other words, when a last time duration of interaction of a specific user of the wait-for-push party is less than an average number-of-day difference of last watching by all the specific users, a total time duration of interaction of the specific user is longer than an average time duration of interaction of all the specific users, and a single time duration of interaction of the specific user is longer than an average frequency of interaction of all the specific users, user-related information of the specific user is maintained, and the specific user is determined as a loyal user of an associated TV program, to facilitate acquisition of user features of the specific user and a target group index of each of the user features. Apparently, any other existing or possible loyalty conditions in the future, if applicable to the present disclosure, should also be covered in the scope of protection of the present disclosure, and are incorporated herein by reference.

In implementations, the operation S404 may further include obtaining user features of the wait-for-push party and a target group index of each of the user features based on user-related information of the specific users of the wait-for-push party, where the target group index includes a ratio between group ratio information of each of the user features in the wait-for-push party and group ratio information of the user feature in a total group; and selecting user group distinct features about the wait-for-push party from the user features based on the target group indices of the user features of the wait-for-push party, and obtaining group ratio information and target group indices of the user group distinct features about the wait-for-push party.

In the foregoing embodiment of the present disclosure, the operation S404 obtains user features of specific users who meet the foregoing loyalty condition(s) of the wait-for-push party for a TV program, which may include age, gender, occupation, ordinary income, etc., based on the user group distinct feature information of the brand, and calculates a TGI′ (Target Group Index) of each specific user feature based on an attribute value (which is recorded as v) of each discrete user feature in user-related information of the specific users. TGI′ of an attribute value v of a user feature “age” of a specific user e of a TV program is recorded as TGI′ (e, v), where TGI′ (e, v)=a group index that is calculated as a percentage of groups having the attribute value v from among groups interacting with the TV program/an interaction data set D′ (e, v) that has the attribute value v and corresponds to all user features interacting with the TV program. In a specific user population of ages of 18 to 26, 92% of specific users have interaction information of watching or buffering activities with the TV program e, while 70% of the total population has interaction information of watching or buffering activities with the TV program e. In this case, the TV program e in the specific user population of the ages of 18 to 26 has a target group index TGI′=92%/70%=131.4%. For another example, in a specific user population of the user feature “female”, 68% of specific users have interaction information of watching or buffering activities with the TV program e, while 40% of the total population has interaction information of watching or buffering activities with the TV program e. In this case, the TV program e in the specific user population of the user feature “female” has a target group index TGI′=68%/40%=170.0%. For another example, in a specific user population of the user feature “white collar”, 90% of specific users have interaction information of watching or buffering activities with the TV program e, while 52% of the total population has interaction information of watching or buffering activities with the TV program e. In this case, the TV program e in the specific user population of the user feature “female” has a target group index TGI′=90%/52%=173.1%.

In the foregoing embodiment of the present disclosure, the user group ratio information of all user group features is obtained based on the user group features, which is recorded as:

$${f}_{ei} = \frac{{count}_{e} ( {v}_{i} )}{{count}_{e}} ,$$

wherein countₑ(vᵢ) represents the number of feature vᵢ in an interaction population of a TV program e, and countₑ represents the size of population watching the TV program e. For example, the total size of population having interaction information with the TV program e is 100, and the number of specific users having the user group feature as “ages of 18 to 26” in the interaction population of the TV program e is 92. In this case, ratio information of the user group with the user group distinct feature “ages of 18 to 26” is determined to be fₑ₁=92%. The number of specific users having a user group distinct feature s “female” in the interaction population of the TV program e is 68. In this case, ratio information of the user group with the user group distinct feature “female” is determined to be fₑ₂=68%. The number of specific users having a user group distinct feature s “white collar” in the interaction population of the TV program e is 90. In this case, ratio information of the user group with the user group distinct feature “white collar” is determined to be fₑ₃=90%.

In the foregoing embodiment of the present disclosure, user group feature information corresponding to the TV program e is obtained based on the user group features and the user group ratio information, which is recorded as:

vectorₑ= [symbol] fₑ₁,fₑ₂, . . . fₑₙ [symbol] ,

which represents vector information constructed from percentages of n pieces of user group ratio information corresponding to specific users interacting with the TV program e. For example, the vector information constructed from the user group ratio information corresponding to the specific users interacting with the TV program e is:

vector_{b}= [symbol] fₑ₁,fₑ₂,fₑ₃ [symbol] = [symbol] 92%,68%,90% [symbol] .

In implementations, the operation S406 may further include calculating a degree of similarity to obtain the user similarity information between the request-to-push party and the wait-for-push party, based on user group ratio information of each distinct feature that is identical in respective user group feature information of the request-to-push party and the wait-for-push party, and corresponding similarity weight information.

In the foregoing embodiment of the present disclosure, the user similarity information between the e-business brand and the TV program is obtained based on count_{b} of the e-business brand, countₑ of the TV program, and the similarity weight information Wi of each user group distinct feature vᵢ using a weighted Euclidean distance algorithm. In implementations, the algorithm may include:

$$d ( {vector}_{b} , {vector}_{e} ) = \sqrt{{w}_{1} {\vert {f}_{b 1} - {f}_{e 1} \vert}^{2} + {w}_{2} {\vert {f}_{b 2} - {f}_{e 2} \vert}^{2} + … + {w}_{n} {\vert {f}_{bn} - {f}_{en} \vert}^{2} } .$$

It should be noted that, in the foregoing embodiment of the present disclosure, the example weighted Euclidean distance algorithm for calculating user similarity information is merely an exemplary embodiment of the present disclosure. Apparently, other existing or possible algorithms in the future that is able to calculate user similarity information, if applicable to the present disclosure, should also be covered in the scope of protection of the present disclosure, and are incorporated herein by reference.

Continuing with the foregoing example, the user similarity information between the e-business brand b and the TV program e, which is obtained based on count_{b} of the e-business brand, countₑ of the TV program, and the similarity weight information Wᵢ of each user group distinct feature vᵢ, is shown as follows:

$$\begin{matrix}d ( {vector}_{b} , {vector}_{e} ) = \sqrt{\begin{matrix}{w}_{1} {\vert {f}_{b 1} - {f}_{e 1} \vert}^{2} + {w}_{2} {\vert {f}_{b 2} - {f}_{e 2} \vert}^{2} + … + \\ {w}_{n} {\vert {f}_{bn} - {f}_{en} \vert}^{2}\end{matrix}} \\ = \sqrt{\begin{matrix}38 \% {\vert 95 \% - 92 \% \vert}^{2} + 26.8 \% {\vert 67 \% - 68 \% \vert}^{2} + \\ 35.2 \% {\vert 88 \% - 90 \% \vert}^{2}\end{matrix}} \\ = 0.022 .\end{matrix}$$

In implementations, the operation S408 may further include determining whether to send the related push information of the request-to-push party to the wait-for-push party for pushing based on a relationship between the user similarity information and a user similarity threshold.

It should be noted that, in the foregoing embodiment of the present disclosure, an example user similarity threshold may be determined based on the capital of the request-to-push party or the precision of the request-to-push party. The user similarity threshold is set s “0.5” as an example herein. Specifically, when the user similarity information is lower than the set user similarity threshold “0.5”, the related push information of the request-to-push party is sent to the wait-for-push party for pushing. Otherwise, the related push information of the request-to-push party is not allowed to be sent the wait-for-push party for pushing. Apparently, other existing or possible methods in the future for setting the user similarity threshold, if applicable to the present disclosure, should also be covered in the scope of protection of the present disclosure, and are incorporated herein by reference.

In implementations, the operation S408 may further include obtaining push priority order information of the wait-for-push party based on the user similarity information, and determining whether to send the related push information of the request-to-push party to the wait-for-push party for pushing based on the push priority order information of the wait-for-push party.

For example, in the foregoing embodiment of the present disclosure, user similarity information <d1, d2, d3 . . . dn> between an e-business brand b and a number of candidate TV programs is obtained. Program push priority order information of the candidate TV programs is obtained based on <d1, d2, d3 . . . dn>. If the program push priority order information of the candidate TV programs is <d3, d6, d7, d10, d11, d1, d4, d2 . . . > in a descending order, that TV programs which user similarity information is ranked in the top three positions are determined to be used as wait-for-push parties <d3, d6, d7> based on respective capitals of the request-to-push parties or respective precisions of the request-to-push parties, and related push information of the e-business brand b is sent to the wait-for-push parties <d3, d6, d7> for pushing.

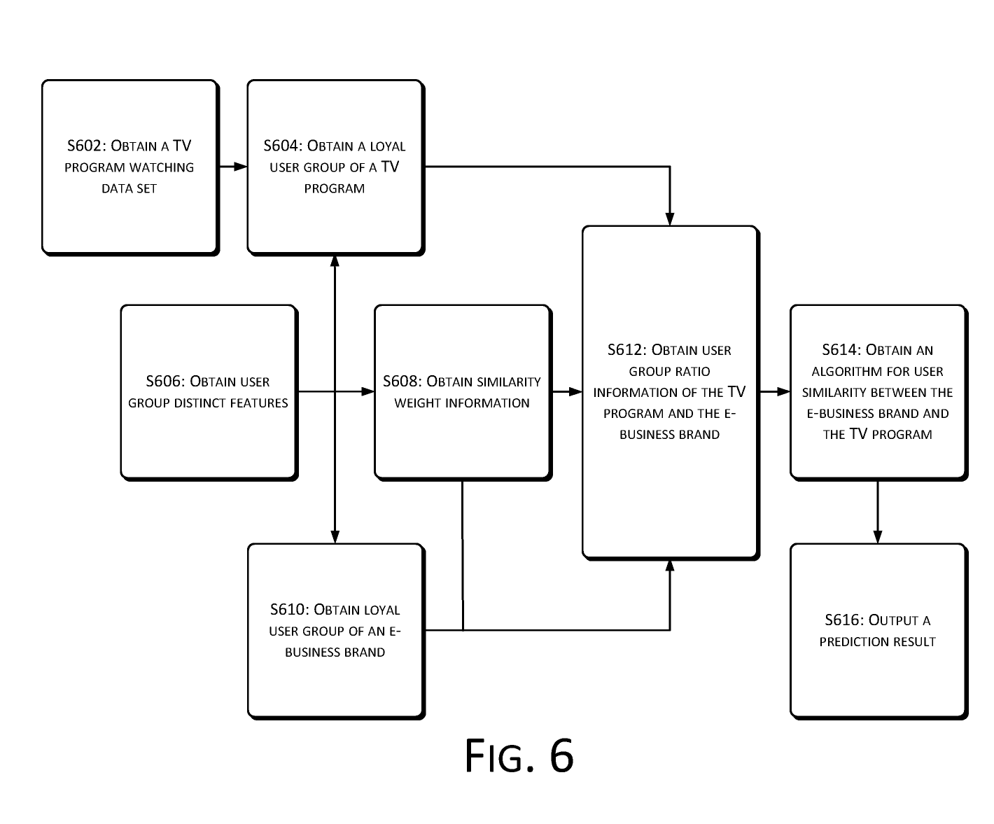

FIG. 6 shows a flowchart of a method 600 for data push according to an exemplary embodiment of the present disclosure. At S602, a TV program watching data set is obtained. At S604, a loyal user group of a TV program is obtained. At S606, user group distinct features are obtained. At S608, similarity weight information is obtained. At S610, a loyal user group of an e-business brand is obtained. At S612, user group ratio information of the TV program and the e-business brand is obtained. At S614, an algorithm for user similarity between the e-business brand and the TV program is obtained. At S616, a prediction result is outputted.

In the foregoing embodiment of the present disclosure, based on user-related information of specific users having an interaction relationship with a TV program, which is obtained at S602, specific users meeting a loyalty condition is mined and obtained to serve as loyal users of the TV program at S604. User group feature information of the specific users of the TV program is obtained at S606. The user group feature information includes features of the specific users of the TV program and ratio information of user groups having the corresponding features, where the features are selected based on distinct features in user group distinct feature information of the e-business brand, that is, corresponding to the distinct features in the user group distinct feature information of the request-to-push party. At S610, interaction information of target users interacting with the e-business brand is obtained, and user group distinct feature information of the target users of the e-business brand is obtained at S606. Similarity weight information is obtained at S608. Through S604, S606, and S610, user group ratio information of the TV program and user group ratio information of the e-business brand are obtained at S612. Through S608 and S612, user group similarity information between the e-business brand and the TV program is calculated using a similarity algorithm at S614. At S616, a determination of whether to send related push information of the request-to-push party to the wait-for-push party for pushing is made based on a relationship between the user similarity information and a user similarity threshold. A determination can be made precisely for sending the related push information of the request-to-push party to corresponding wait-for-push part(ies) which meet(s) a condition for pushing, so that the entire data push process is calculated via scientific big data analysis, thus more effectively improving the precision and intellectualization of data push.

As compared with existing technologies, the method and the device for data push according to the embodiments of the present disclosure obtain user-related information of target users of a request-to-push party, obtain user group distinct feature information about the request-to-push party based on the user-related information of the target users of the request-to-push party, and obtain similarity weight information of each distinct feature based on the user group distinct feature information of the request-to-push party, obtain user-related information of specific users of a wait-for-push party, and obtain user group feature information about the wait-for-push party based on the user-related information of the specific users of the wait-for-push party. By separately analyzing the user-related information of the target users of the request-to-push party and the user information of the specific users of the wait-for-push party, the user group distinct feature information (i.e., similarity weight information) of the request-to-push party and the user group feature information of the wait-for-push party is obtained, thus avoiding interference due to subjective factors. As such, the user-related information can be processed quantitatively, thus effectively improving the intellectualization of the data push process. Furthermore, based on the similarity weight information, the user group distinct feature information of the request-to-push party, and the user group feature information of the wait-for-push party, user group similarity information between the request-to-push party and the wait-for-push party is obtained, thus enabling effectively and quickly calculation of the user group similarity information between the request-to-push party and the wait-for-push party. Furthermore, it is determined, based on the user group similarity information, whether to send the related push information of the request-to-push party to the wait-for-push party for pushing. Moreover, a determination of whether to send related push information of the request-to-push party to the wait-for-push party for pushing is made based on the user group similarity information. Therefore, the related push information of the request-to-push party can be precisely sent to the wait-for-push party for pushing, so that the entire data push is calculated via a scientific big data analysis, thus more effectively improving the precision and intellectualization of data push.

It should be noted that, the present disclosure can be implemented in software and/or a combination of software and hardware. For example, an application-specific integrated circuit (ASIC), a general purpose computer or any other similar hardware equipment may be used for implementation. In an embodiment, a software program of the present disclosure may be executed by processor(s) to execute the operations or functions described above. Similarly, a software program of the present disclosure (including related data structures) may be stored in computer-readable recording media, for example, a RAM memory, a magnetic drive or an optical drive, or a floppy disk and similar equipment. In addition, some operations or functions of the present disclosure may be implemented using hardware. For example, a circuit may coordinate with processor(s) and execute the operations or functions.

Moreover, a part of the present disclosure may be applied as a computer program product, such as computer program instruction(s), which, when executed by a computer, can invoke or provide the disclosed method and/or technical solution through the operations of the computer. The program instruction(s) that invoke(s) the disclosed method may be stored in a fixed or mobile recording media, and/or transmitted via data streams in radio or other signal carrying media, and/or stored in a working memory of computer equipment that runs according to the program instruction(s). An embodiment according to the present disclosure may include a device herein. The device may include memory for storing computer program instruction(s), and processor(s) for executing the program instruction(s). The computer program instruction(s), when executed by the processor(s), cause(s) the device to run the method(s) and/or technical solution(s) that are based on the foregoing embodiments of the present disclosure.

Apparently. one skilled in the art should understand that the present disclosure is not limited to the details of the foregoing exemplary embodiments, and the present disclosure can be implemented in other specific forms without departing from the spirit or basic features of the present disclosure. Therefore, these embodiments should be regarded as examples rather than limitations in every aspect. The scope of the present disclosure is defined by the appended claims rather than the foregoing description. Therefore, the present disclosure is intended to cover all variations that fall within the meaning and scope of equivalent elements of the claims. No reference labels in the claims should be regarded as limitations to the related claims. In addition, the term “comprise” apparently does not exclude other units or operations, and a singular form does not exclude a plural form. Multiple units or devices recited in a device claim may also be implemented by a single unit or device via software or hardware. Terms such as “first” and “second” are used for representing names, but do not represent any particular order.

What is claimed is:

1. A method implemented by one or more computing devices, the method comprising:
obtaining user-related information of a plurality of target users of a request-to-push party;
determining user group distinct feature information about the request-to-push party based at least in part on the user-related information of the target users of the request-to-push party;
determining similarity weight information of each distinct feature based at least in part on the user group distinct feature information of the request-to-push party, the user group distinct feature information including distinct features and ratio information of user groups having the distinct features;
obtaining user-related information of a plurality of specific users of a wait-for-push party;
determining user group feature information about the wait-for-push party based at least in part on the user-related information of the specific users of the wait-for-push party;
determining user group similarity information between the request-to-push party and the wait-for-push party based at least in part on the similarity weight information, the user group distinct feature information of the request-to-push party, and the user group feature information of the wait-for-push party; and
determining whether to send related push information of the request-to-push party to the wait-for-push party for pushing based at least in part on the user group similarity information.

2. The method of claim 1, wherein determining the user-related information of the plurality of target users of the request-to-push party comprises:
obtaining multiple pieces of user interaction information of the plurality of target users of the request-to-push party; and
determining user attribute information of the target users based at least in part on the user interaction information.

3. The method of claim 2, wherein the user attribute information comprises at least one of user population attribute information, user behavior feature information, or user interest and preference information.

4. The method of claim 1, wherein determining the user group distinct feature information about the request-to-push party comprises:
obtaining user features of the plurality of target users of the request-to-push party and respective target group indices of the user features based at least in part on the user-related information of the plurality of target users of the request-to-push party, wherein a target group index of the respective target group indices includes a ratio between user group ratio information of a user feature of the user features in the request-to-push party and user group ratio information of the user feature in an entire user group;
selecting user group distinct features about the request-to-push party from the user features based at least in part on the target group indices of the user features of the request-to-push party;
obtaining user group ratio information and target group indices of the user group distinct features about the request-to-push party; and
obtaining the similarity weight information based on the user group distinct feature information of the request-to-push party, wherein the similarity weight information comprises information about a ratio between a target group index of each user group distinct feature of the request-to-push party and a sum of the target group indices of the user group distinct features of the request-to-push party.

5. The method of claim 4, wherein selecting the user group distinct features about the request-to-push party from the user features comprises selecting a particular user feature of the request-to-push party as a user group distinct feature in response to determining that a target group index of the particular user feature is higher than an index threshold.

6. The method of claim 1, wherein obtaining the user-related information of the plurality of specific users of the wait-for-push party comprises:
obtaining user loyalty information of the wait-for-push party based at least in part on the user-related information of the plurality of specific users of the wait-for-push party; and
screening the user-related information of the plurality of specific users of the wait-for-push party based at least in part on the user loyalty information.

7. The method of claim 6, wherein screening the user-related information of the plurality of specific users of the wait-for-push party comprises:
comparing respective user loyalty information of a specific user of the wait-for-push party with average user loyalty information associated with all specific users of the wait-for-push party; and
maintaining respective user-related information of the specific user in response to a result of the comparing meeting a loyalty condition.

8. The method of claim 6, wherein the user loyalty information comprises at least one of a frequency of interaction, a time duration of single interaction, a total time duration of interaction, an average time duration of interaction, or a last valid interaction time between a specific user and the wait-for-push party.

9. The method of claim 1, wherein determining the user group similarity information between the request-to-push party and the wait-for-push party comprises calculating a degree of similarity to obtain the user similarity information between the request-to-push party and the wait-for-push party based at least in part on user group ratio information of a distinct feature that is identical in the user group feature information of the request-to-push party and the user group feature information of the wait-for-push party, and the similarity weight information corresponding to the distinct feature.

10. The method of claim 1, wherein determining whether to send the related push information of the request-to-push party to the wait-for-push party comprises determining whether to send the related push information of the request-to-push party to the wait-for-push party for pushing based at least in part on a relationship between the user group similarity information and a user similarity threshold.

11. The method of claim 1, wherein determining whether to send the related push information of the request-to-push party to the wait-for-push party comprises:
obtaining push priority order information of the wait-for-push party based at least in part on the user group similarity information; and
determining whether to send the related push information of the request-to-push party to the wait-for-push party for pushing based at least in part on the push priority order information of the wait-for-push party.

12. One or more computer-readable media storing executable instructions that, when executed by one or more processors, cause the one or more processors to perform acts comprising:
obtaining user-related information of a plurality of target users of a request-to-push party;
determining user group distinct feature information about the request-to-push party based at least in part on the user-related information of the target users of the request-to-push party;
determining similarity weight information of each distinct feature based at least in part on the user group distinct feature information of the request-to-push party, the user group distinct feature information including distinct features and ratio information of user groups having the distinct features;
obtaining user-related information of a plurality of specific users of a wait-for-push party;
determining user group feature information about the wait-for-push party based at least in part on the user-related information of the specific users of the wait-for-push party;
determining user group similarity information between the request-to-push party and the wait-for-push party based at least in part on the similarity weight information, the user group distinct feature information of the request-to-push party, and the user group feature information of the wait-for-push party; and
determining whether to send related push information of the request-to-push party to the wait-for-push party for pushing based at least in part on the user group similarity information.

13. The one or more computer-readable media of claim 12, wherein determining the user-related information of the plurality of target users of the request-to-push party comprises:
obtaining multiple pieces of user interaction information of the plurality of target users of the request-to-push party; and
determining user attribute information of the target users based at least in part on the user interaction information.

14. The one or more computer-readable media of claim 12, wherein determining the user group distinct feature information about the request-to-push party comprises:
obtaining user features of the plurality of target users of the request-to-push party and respective target group indices of the user features based at least in part on the user-related information of the plurality of target users of the request-to-push party, wherein a target group index of the respective target group indices includes a ratio between user group ratio information of a user feature of the user features in the request-to-push party and user group ratio information of the user feature in an entire user group;
selecting user group distinct features about the request-to-push party from the user features based at least in part on the target group indices of the user features of the request-to-push party;
obtaining user group ratio information and target group indices of the user group distinct features about the request-to-push party; and
obtaining the similarity weight information based on the user group distinct feature information of the request-to-push party, wherein the similarity weight information comprises information about a ratio between a target group index of each user group distinct feature of the request-to-push party and a sum of the target group indices of the user group distinct features of the request-to-push party.

15. The one or more computer-readable media of claim 12, wherein obtaining the user-related information of the plurality of specific users of the wait-for-push party comprises:
obtaining user loyalty information of the wait-for-push party based at least in part on the user-related information of the plurality of specific users of the wait-for-push party; and
screening the user-related information of the plurality of specific users of the wait-for-push party based at least in part on the user loyalty information.

16. The one or more computer-readable media of claim 12, wherein determining the user group similarity information between the request-to-push party and the wait-for-push party comprises calculating a degree of similarity to obtain the user similarity information between the request-to-push party and the wait-for-push party based at least in part on user group ratio information of a distinct feature that is identical in the user group feature information of the request-to-push party and the user group feature information of the wait-for-push party, and the similarity weight information corresponding to the distinct feature.

17. The one or more computer-readable media of claim 12, wherein determining whether to send the related push information of the request-to-push party to the wait-for-push party comprises determining whether to send the related push information of the request-to-push party to the wait-for-push party for pushing based at least in part on a relationship between the user group similarity information and a user similarity threshold.

18. The one or more computer-readable media of claim 12, wherein determining whether to send the related push information of the request-to-push party to the wait-for-push party comprises:
obtaining push priority order information of the wait-for-push party based at least in part on the user group similarity information; and
determining whether to send the related push information of the request-to-push party to the wait-for-push party for pushing based at least in part on the push priority order information of the wait-for-push party.

19. A device comprising:
one or more processors;
memory;
a request-to-push party acquisition apparatus stored in the memory and executable by the one or more processors to:
obtain user-related information of a plurality of target users of a request-to-push party,
determine user group distinct feature information about the request-to-push party based at least in part on the user-related information of the plurality of target users of the request-to-push party, and
determine similarity weight information of each distinct feature based at least in part on the user group distinct feature information of the request-to-push party, wherein the user group distinct feature information includes distinct features and ratio information of user groups having the distinct features;
a wait-for-push party acquisition apparatus stored in the memory and executable by the one or more processors to:
obtain user-related information of a plurality of specific users of a wait-for-push party, and
determine user group feature information of the wait-for-push party corresponding to the user group distinct feature information of the request-to-push party based at least in part on the user-related information of the plurality of specific users of the wait-for-push party;
a similarity calculation apparatus stored in the memory and executable by the one or more processors to determine user group similarity information between the request-to-push party and the wait-for-push party based at least in part on the similarity weight information, the user group distinct feature information of the request-to-push party, and the user group feature information of the wait-for-push party; and
a determination apparatus stored in the memory and executable by the one or more processors to determine whether to send related push information of the request-to-push party to the wait-for-push party for pushing based at least in part on the user group similarity information.

20. The device of claim 19, wherein the request-to-push party acquisition apparatus comprises:
a first acquisition unit to obtain user features of the plurality of target users of the request-to-push party and respective target group indices of the user features based on the user-related information of the plurality of target users of the request-to-push party, wherein a target group index of the target group indices includes a ratio between user group ratio information of a corresponding user feature of the user features in the request-to-push party and user group ratio information of the corresponding user feature in an entire user group;
a second acquisition unit to:
select the distinct features about the request-to-push party from the user features based on the target group indices of the user features of the request-to-push party, and
obtain user group ratio information and target group indices of the distinct features about the request-to-push party; and
a third acquisition unit to obtain the similarity weight information based at least in part on the user group distinct feature information of the request-to-push party, wherein the similarity weight information comprises information about respective ratios between the target group indices of the distinct features of the request-to-push party and sums of the target group indices of the distinct features of the request-to-push party.
